(19) United States
(12) Patent Application Publication
(10) Pub. No.: US 2012/0103725 A1
(43) Pub. Date: May 3, 2012

(54) LOWERING DEVICE COMPRISING A SWIVEL ARM HAVING CONTOURED BRAKING MEANS

(75) Inventors: Per Johansson, Karlstad (SE); Anders Lindgren, Karlstad (SE); Carl Backlund, Stockholm (SE)

(73) Assignee: INITIUM SYSTEM AKTIEBOLAG, Karlstad (SE)

(21) Appl. No.: 13/320,312

(22) PCT Filed: May 11, 2010
(86) PCT No.: PCT/SE10/50515

§ 371 Date: Dec. 21, 2011

(30) Foreign Application Priority Data
May 13, 2009 (SE) 0950335-0

(51) Int. Cl. A62B 1/14

(52) U.S. Cl. 182/5

(57) ABSTRACT

The present invention relates to a lowering device (1), comprising a base part (2), a handle (3), a lifeline (4) and an attachment (7) for a rescue harness or a safety belt, wherein the base part (2) and the handle (3) are fixedly connected to each other, wherein the base part (2) comprises a first deflecting means (5) and a second deflecting means (6), that said first deflecting means (5) also constitutes a braking means located adjacent to an outlet opening (10) for the lifeline (4), that a first, incoming portion (4a) of the lifeline is adapted to run around said first deflecting means (5) while bearing against a contact surface (A) of said first deflecting means, that a second, outgoing portion (4b) of the lifeline is adapted to run around said second deflecting means (6) and further out through the outlet opening (10) while when under load it abuts in frictional engagement against the first, incoming portion (4a) of the lifeline along at least part of the length where the first lifeline bears against said contact surface (A), that a fulcrum (M) is formed in an abutment region between the two portions (4a, 4b) of the lifeline and the contact surface (A), that the handle (3) and the attachment (7) are positioned on either side of the first deflecting means (5) and adapted to rotate the base part (2) in a common rotational plane (P) about this fulcrum (M), that the attachment (7) comprises a swivel arm which is rotatably connected to the base part (2) on a pivot point (8) for rotation of the swivel arm in said rotational plane (P) and an attachment means (11) for said rescue harness or safety belt, wherein the swivel arm is designed to be brought into engagement with said second portion (4b) of the lifeline in the abutment region between the two portions (4a, 4b) of the lifeline and the contact surface (A) for producing a compressive force (F) against the lifeline, whereby the abutment contact between the two portions of the lifeline, and thereby the frictional force, can be increased.

### TECHNICAL FIELD

The present invention relates to a lowering device, comprising a base part, a handle, a lifeline and an attachment for a rescue harness or a safety belt, wherein the base part and the handle are fixedly connected to each other, wherein the base part comprises a first deflecting means and a second deflecting means, that said first deflecting means also constitutes a braking means located adjacent to an outlet opening for the lifeline, that a first, incoming portion of the lifeline is adapted to run around said first deflecting means while bearing against a contact surface of said first deflecting means, that a second, outgoing portion of the lifeline is adapted to run around said second deflecting means and further out through the outlet opening while when under load it abuts in frictional engagement against the first, incoming portion of the lifeline along at least part of the length where the first lifeline bears against said contact surface, that a fulcrum is formed in an abutment region between the two portions of the lifeline, and that the handle and the attachment are positioned on either side of the first attachment means and adapted to rotate the base part in a common rotational plane about this fulcrum, that the attachment comprises a swivel arm, which is rotatably connected to the base part on a pivot point for rotation of the swivel arm in said rotational plane.

### STATE OF THE ART

It has been desired for a long time to be able to provide simple and relatively cheap safety devices for lowering oneself down, so called lowering brakes, to be used by persons in distress in an evacuation, for example in connection with fires in private homes, in public buildings or other premises, or when rescuing persons in, for example, lifts, ski lifts, or travelling cranes that have stopped working.

Devices for securing persons at great heights, for example on a construction site or when mountaineering, have been known for quite a long time. In most cases, these devices comprise some kind of safety harness or safety belt which is connected to a lifeline, which in its turn is anchored to a suitable point in order to prevent the person from falling to the ground if he/she should trip or loose his/her footing.

An important function of these devices is that they should automatically lock the lifeline against sliding. Accordingly, the secured person should not have to actuate the device so as to get it to arrest the fall. At the same time, it is desired that the device should be easy to handle in order to minimize the risk that it will not function as intended due to an incorrect handling.

A device intended to automatically retard the fall of a person being connected to the device is disclosed by SE 371 933. The device is designed for locking a first belt or rope (6) in that the rope runs around two contact means (2, 3) and abuts in frictional engagement against itself when under load. By actuating the device with a handle (7), the braking force can be reduced and lowering becomes possible.

Similar devices are disclosed in U.S. Pat. No. 3,340,964, JP 54-42898 and JP 50-76894.

These devices exhibit the disadvantage that, when the device is rotated in order to increase the lowering speed, there is no catch which prevents the device from being handled so that the braking force obtained by the frictional engagement is lost completely. This means that there is an obvious risk that an individual may fall to the ground, essentially in a free-fall.

Previously, the applicant has offered a solution to this problem. EP 1622687 discloses a lowering device, where an individual handling the lifeline in the above-described incorrect manner cannot fall to the ground. In a so-called panic position, i.e. when an individual hangs on to the handle and thus reduces the frictional engagement to a minimum, a second frictional engagement sets in between other portions of the lifeline and the lowering speed will be retarded and finally braked completely. However, it has been found that this device does not fulfil all requirements on handling ability. Among other things, it has been found to be difficult to adjust the position of the lowering device along the lifeline in an unloaded condition. Furthermore, the braking action in the so-called panic position is very strong, which results in a very strong retardation that may be perceived as uncomfortable. Furthermore, the transition from the panic position to a lowering operation has not been perceived to be as safe and comfortable for the user as desired.

### BRIEF DESCRIPTION OF THE INVENTION

It is an object of the present invention to eliminate or at least minimize the above-mentioned problems, which is achieved in that the lowering device comprises a swivel arm, which is rotatably connected to the base part on a pivot point for rotation of the arm in said rotational plane, wherein the swivel arm is designed to be brought into engagement with said second portion 4b of the lifeline in the abutment region between the two portions 4a, 4b of the lifeline and the contact surface A for producing a compressive force F against the lifeline whereby the abutment contact between the two portions of the lifeline, and thereby the frictional force, can be increased.

Thanks to the invention, the problem of adjusting the position of the lifeline when the lifeline is unloaded is solved, which is a major improvement of the handling ability, at the same time as the lowering device prevents a free-fall in a panic position. Furthermore, a smooth braking action is obtained, due to the fact that the compressive force will increase gradually.

According to another aspect of the invention, the compressive force can be produced by a moderate rotation of the lowering device, in a position before free-fall starts, which is achieved in that said engagement against the lifeline is produced by a portion 9 of the swivel arm protruding in said rotational plane P. At the same time, the pivot point 8 can be positioned at a distance from the first deflecting means, which results in a leverage sufficient to ensure a reliable locking in a non-actuated position.

According to another aspect of the invention, the compressive force can be made relatively large in that said protruding portion 9 is positioned in a position between the pivot point 8 and an attachment means 11 for said rescue harness or safety belt, wherein the swivel arm forms a one-armed lever where the actuating force is adjusted by rotation of the base part 2 so that a rotation angle v formed between a longitudinal axis 13 of the attachment arm and a longitudinal axis 14 of the handle is decreased or increased.

According to other aspects:
the transmission ratio of the swivel arm amounts to a factor of at least 1:1, preferably at least 1:2, wherein the compressive force it exerts on the lifeline becomes so large that the rotation angle v between a self locking position, SLP (Self Locking Position), and a panic position, PLP (Panic Locking Position), amounts to a maximum of 90°, preferably a maximum of 75°. This also contributes to the fact that a safe operation can be ensured in the panic position, although the adjustment requires only a modest effort by the person controlling the lowering operation;
the rotation angle v for controlling the lowering operation amounts to a maximum of 45°, which provides a safety margin of about 30° in the upper part of the control range in which the lowering device is self-locking;
said first deflecting member 5 has an oval/elliptical shape where the contact surface A is positioned along the side having the largest circle radius, wherein a longer contact length between the two portions of the lifeline is obtained, which results in a smoother adjustment of the lowering speed. Furthermore, the risk that the lifelines align themselves laterally to each other is eliminated, or at least reduced. Also, because of this, local overheating of the deflecting means, which could affect the material strength and the operational safety of the lowering device, is avoided.

### BRIEF DESCRIPTION OF THE FIGURES

In the following, the invention will be described in greater detail with reference to the accompanying figures of the drawings, in which:

FIG. 1 shows a perspective view of a lowering device according to the invention;

FIG. 2 shows a plan view of the lowering device according to a preferred embodiment, with one half of its casing removed so that its internal parts and the lifeline are evident;

FIG. 3 shows a plan view of FIG. 2 in a self locking position;

FIG. 4 shows a plan view of FIG. 2 in a lowering position; and

FIG. 5 shows a plan view of FIG. 2 in a panic position.

### DETAILED DESCRIPTION OF THE FIGURES

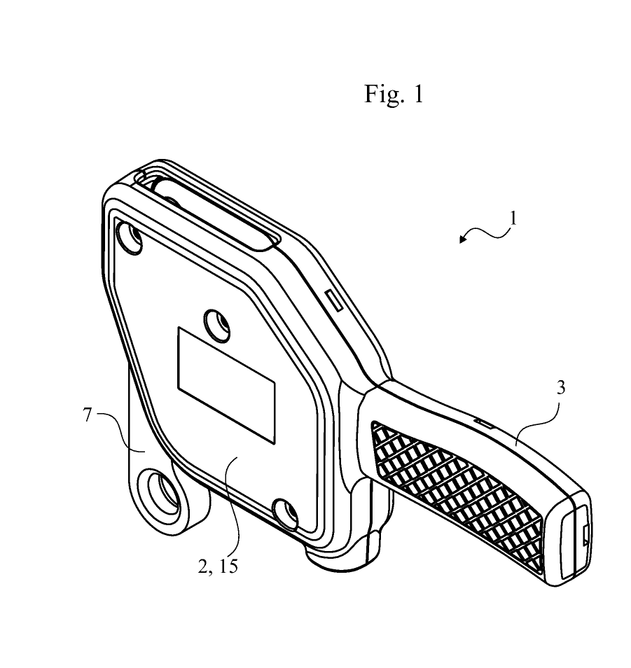

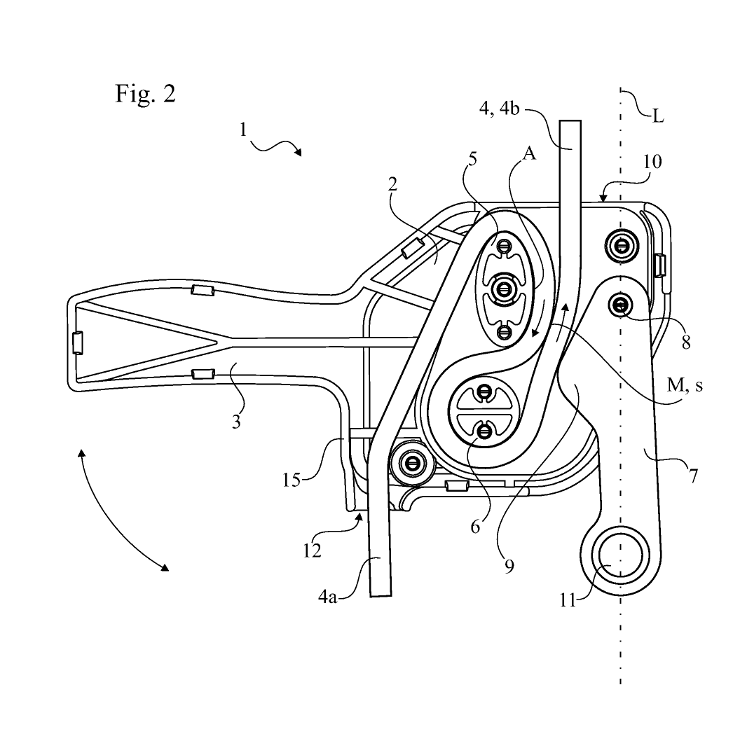

FIG. 1 shows a perspective view of a lowering device 1 according to the invention, comprising a base part 2, which comprises attachments for a number of deflecting means (see FIG. 2) and a swivel arm 7. The base part is preferably accommodated within, and fixed to, a protective casing 15. Furthermore, the lowering device comprises a handle 3, a lifeline (see FIG. 2), and an attachment 7 for a rescue harness or a safety belt.

FIG. 2 shows a plan view of the lowering device 1 according to a preferred embodiment with part of its casing removed so that its internal parts and the lifeline are evident. The base part 2 and the handle 3 are fixedly connected to each other. Preferably, the handle constitutes an integrated part of the casing 15. The base part 2 comprises a first deflecting means 5 for the lifeline located in the upper portion of the base part adjacent to an outlet opening 10 for the lifeline 4. In the lower portion of the base part, there is a second deflecting means 6, positioned slightly closer to the handle 3 than the first deflecting means 5, and an inlet 12. In this way, the contact surfaces of the lifeline around the respective deflecting means will become longer than if the deflecting means were positioned more in line with each other.

The first deflecting means 5 constitutes a braking means in that the lifeline is adapted to abut in frictional engagement against itself adjacent to this first deflecting means, indicated with arrows in the Figure. Accordingly, an incoming portion 4a meets an outgoing portion 4b adjacent to this first deflecting means. The frictional engagement is achieved by causing the incoming portion of the lifeline to run in a S-shape around the two deflecting means. The incoming portion of the lifeline runs from the inlet opening 12, starting around the first deflecting means 5 while bearing against a contact surface A facing toward the side of the base part 2 where the attachment 7 and the outlet opening 10 are located. Thereafter, the lifeline runs downward and around the second deflecting means 6, whereupon it runs further upward and out through the outlet opening 10. According to a preferred embodiment of the invention, in a loaded condition, the outgoing portion of the lifeline will abut in frictional engagement against the first, incoming portion along at least part of the length where the first lifeline bears against said contact surface A. Accordingly, for the length s where a frictional engagement is present, the following relationship applies: 0<s≦A.

It is an advantage if the first deflecting means is given an oval shape and mounted so that the long side of the oval is directed toward the attachment 7. The long side of the oval refers to the side having the largest radius of curvature. In that way, a relatively long contact surface A is obtained, without the lowering device therefore becoming unnecessarily large. A longer contact surface enables a longer distance s in which the lifeline can be brought into frictional engagement against itself. This leads to an improved speed control during the lowering operation, and reduces the local stress on the lifeline in abutment regions around the deflecting means, in the frictional engagement. It also reduces the local stress in the region of the contact surface A on the deflecting means 5.

In a preferred embodiment, the deflecting means are made of metal, preferably light metal, which, in addition to being light weight, also has good thermal conductivity. Suitably, the deflecting means can be manufactured by extrusion in order to keep the manufacturing cost down. The casing, which also comprises the handle, is suitably made of injection-moulded thermosetting plastic. Naturally, other materials fulfilling the purpose can be used.

A fulcrum M is formed adjacent to the first deflecting means, in the region of the frictional engagement of the lifeline. The handle 3 and the attachment 7 are placed on either side of the first deflecting means 5 and adapted to rotate the base part 2 in a common rotational plane around this fulcrum M. The rotational plane extends substantially in parallel with the base part 2, and the rotation is produced under the influence of the intrinsic weight of the individual, alternatively the actuation of the handle with a counter-directed force. The attachment 7 comprises a swivel arm, which is rotatably connected to the base part 2 on a pivot point 8 for rotation of the swivel arm in said rotation plane. At its lower end, the swivel arm also comprises some kind of attachment means 11, here an aperture, onto which an individual can secure himself/herself.

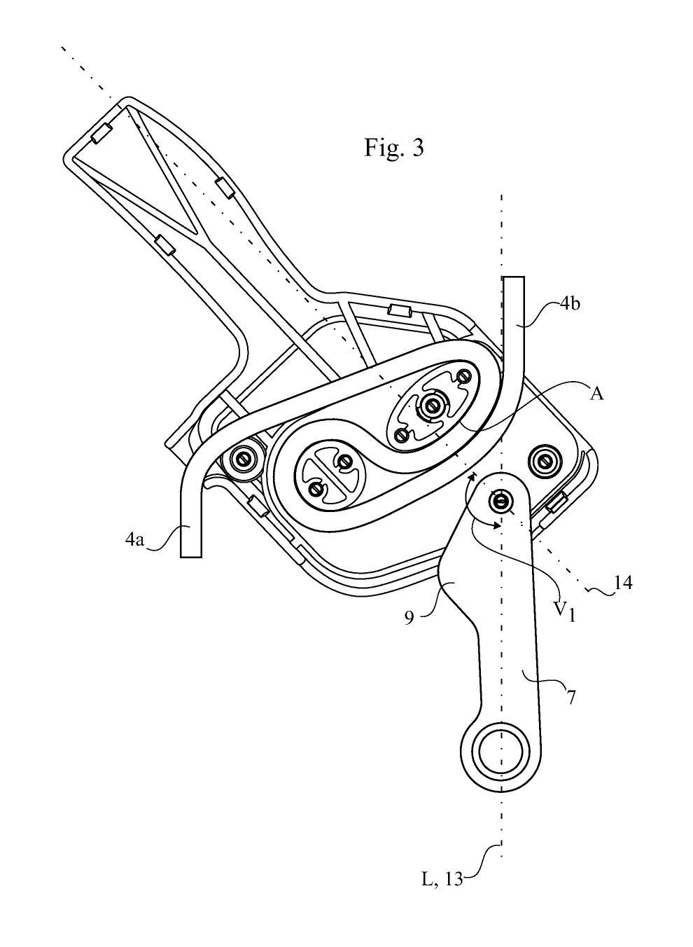

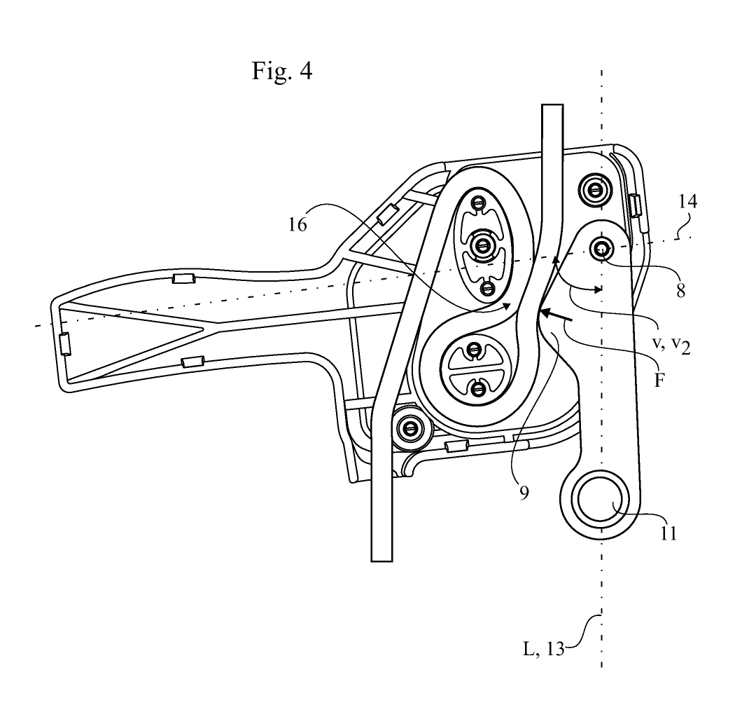

The function of the lowering device will now be described with reference to FIGS. 3-5. FIG. 3 shows the lowering device in the self locking position. The self locking position means a position where the lowering device is not influenced by any force on the handle. Here, it is seen how the outgoing portion 4b of the lifeline abuts in frictional engagement against the incoming portion 4a along the major part of the contact surface A. In the self locking position, the outgoing portion 4b of the lifeline and the longitudinal axis 13 of the swivel arm 7 coincide in a vertical line L, which provides maximum engagement, i.e. the greatest braking action, which is shown in FIG. 4. To relieve the braking force, a counter-directed force is applied on the handle so that it is moved downward, wherein the abutment contact between the two portions of the lifeline is successively reduced. In a certain position, depending on the weight of the individual, the braking force is no longer sufficient to lock the line. The lowering operation will start. The individual can then adjust the lowering speed by varying the rotation of the base part, i.e. by increasing and decreasing the length where the portions of the lifeline abut against each other in frictional engagement. Thanks to the fact that the first deflecting means, in a preferred embodiment, has been given an oval shape, a substantially improved control of the lowering speed is obtained.

The swivel arm is designed to be brought into engagement with said second portion 4b of the lifeline in the section where the lifeline is in frictional engagement against itself, i.e. in the abutment region between the two portions 4a, 4b of the lifeline and the contact surface A. The above-mentioned engagement against the lifeline is produced by a portion 9 of the swivel arm protruding in said rotational plane, see FIG. 4. In that way, a compressive force F against the lifeline can be produced, whereby the two portions of the lifeline will be pressed together in a nip formed between the contact surface A of the braking means and the protruding portion 9. The protruding portion is positioned in a position between the pivot point 8 and the attachment means 11 for said rescue harness or safety belt. Thus, the swivel arm forms a one-armed lever where the compressive force F is adjusted by rotation of the base part in the rotational plane, wherein a rotation angle v formed between a longitudinal axis 13 of the swivel arm and a line 14 parallel with a longitudinal axis of the handle is decreased or increased.

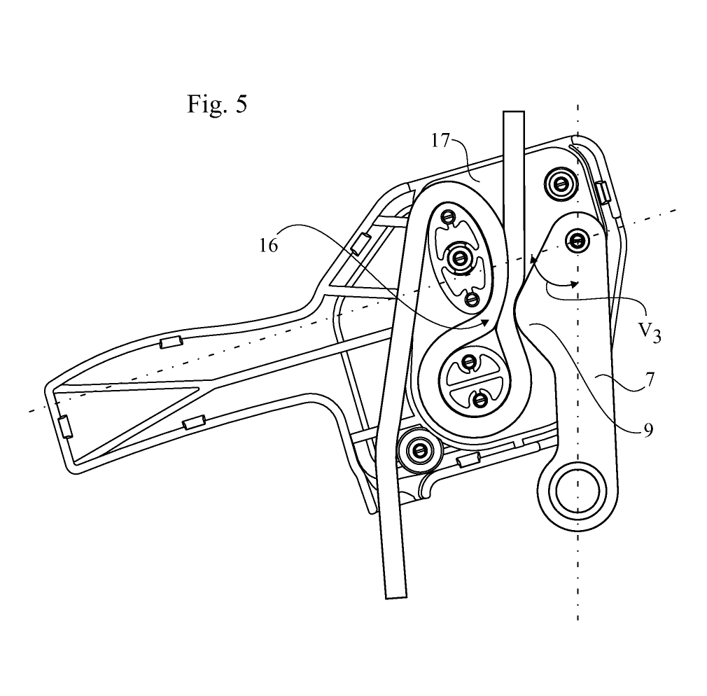

Preferably, the swivel arm is given such a length that its transmission ratio amounts to a factor of at least 1:1, preferably at least 1:2, wherein the compressive force F it exerts on the lifeline becomes so large that the rotation angle v between a self locking position, SLP (Self Locking Position), and a panic position, PLP (Panic Locking Position), see FIG. 5, amounts to a maximum of about 100°, preferably a maximum of about 75°. Furthermore, it is an advantage if the rotation angle v for controlling the lowering operation amounts to a maximum of about 45°. The skilled person will appreciate that these angular specifications are approximate, since the weight of the individual which is to be lowered down will result in different rotation angles. As far as the self locking position is concerned, it is an advantage if there is a safety margin of at least 20°, more preferably at least 30°, in the upper part of the control range in which the lowering device is self-locking, also in the case when a heavy individual is to be lowered down.

Furthermore, it is an advantage if the protruding portion 9 of the swivel arm is brought into engagement with the lifeline 4 when the rotation angle v has been decreased with at the most 45° from a maximum in the self locking position. In that way, the abutment contact between the two portions 4a, 4b of the lifeline will have an extension amounting to at least half of the total extension of the contact surface A. This guarantees that the compressive force F from the swivel arm sets in at an early stage of the lowering operation, i.e. before the lowering device has been rotated so far that the lowering speed might be perceived as unnecessarily high by some people. In that way, a smooth control of the lowering speed can be obtained. It is also appreciated that the compressive force F from the swivel arm, which contributes to an increased frictional force during the lowering operation, enables a reduction of the frictional forces around the deflecting means, which has been an object of the invention, with the purpose of enabling an easier adjustment of the position of the lowering device along the lifeline.

According to a preferred embodiment, the first deflecting means 5 is given an elliptical shape where the contact surface A is positioned along the side having the largest circle radius. In that way, the advantage is achieved that a longer contact length is obtained, i.e. a larger friction creating surface A between the two portions of the lifeline and between the incoming portion 4b of the lifeline and its outgoing portion 4b. When rotating the lowering device from the self locking position to a lowering position, the contact surface between the incoming portion of the lifeline will maintain a relatively long contact length against the first deflecting means 5, whereas the length s for frictional engagement between the two portions of the lifeline will be reduced at a different rate, due to the elliptical shape of the deflecting means. In that way, a combination effect of the frictional forces is obtained, which has been possible to use in order to obtain a substantially improved functionality of the lowering device. Among other things, a more controlled and smoother adjustment of the lowering speed has been possible to obtain.

Accordingly, the change of the length for frictional engagement ds in relation to the change of the rotation angle dv, (ds/dv), is smallest during the initial rotation of the lowering device, in the upper control range where the circle radius of the deflecting means is at its smallest, which provides a safety margin of at least 20° in the self locking position. In the following control range, i.e. the lowering range, the length for frictional engagement will, on the other hand, change more rapidly in relation to the corresponding change of the rotation angle, since the abutment contact in this control range takes place in the portion where the circle radius of the deflecting means is at its largest. Accordingly, dv/ds is at its largest in the lowering control range. Due to the influence from the swivel arm, at least in the lower control range for lowering, a continued increase of the lowering speed can be prevented, which has been another object of the invention.

Finally, FIG. 5 shows the lowering device in a panic position, PLP (Panic Locking Position). Here, the handle of the lowering device has been rotated further downward, past the lowering control range, to a position where the lowering operation has stopped. Here, it can be seen how the protruding portion 9 on the swivel arm 7 forms a very narrow nip 16 against the lower portion of the braking means 5. It is appreciated that, without the influence of the swivel arm, the braking frictional forces would be at a minimum in this position. Thanks to the influence from the swivel arm, by means of a lowering device according to the invention, the frictional forces can be increased until the lowering operation is stopped completely.

For the purpose of maintaining the lifelines in correct relative position, i.e. in order to prevent that the lifelines align themselves laterally to each other, which could substantially impair the function, the base unit 2 of the lowering device is also provided with two side supporting walls 17 positioned on either side of the deflecting means. The front side supporting wall has been removed in the figures to enable illustration of the interior of the lowering device. These side supporting walls also provide a stable attachment for the deflecting means and the casing. Furthermore, the inside of the casing has been provided with rims and holes for through-going screws which retain the walls in the correct position inside the base part. Preferably, the walls are made of a material having good wear resistance and providing good strength. In the preferred embodiment, the walls are made of light metal plates.

The skilled person will appreciate that the side supporting walls should be adapted to the dimension of the lifeline, but that the gap between them cannot be made too narrow, since the friction which would arise between the lifeline and the walls would mean that the purpose of being able to adjust the position of the lowering device along the lifeline would not be achieved. If the portions of the lifeline, contrary to expectation, would align themselves laterally to each other, e.g. due to overloading, the side supporting walls will to a certain extent take over the function of the swivel arm, since the limited available width which is offered can be likened to a nip. However, also in such a situation, the swivel arm will provide a frictional force in its contact with the two portions of the lifeline. It is appreciated that the swivel arm constitutes an additional safety factor in such a situation.

As mentioned above, the side supporting walls cannot be positioned too close together. For that reason, it has been desired to further minimize the risk that the two portions of the lifeline align themselves laterally to each other. Also in this context, the solution according to the invention has proven advantageous. Thanks to the fact that the frictional engagement is formed along a considerably longer length when the first deflecting means (braking means) is elliptical, a further improvement is achieved with respect to the risk that the lifelines align themselves laterally to each other. It has been found that this shape eliminates, or at least minimizes, the risk that the lifelines align themselves laterally to each other. Because of this, also local overheating of the deflecting means, which could influence the material strength and the operational safety of the lowering device, is avoided.

### Alternative Embodiments

The invention is not limited by what has been described hereinabove, but can be varied within the scope of the following claims. For example, it is appreciated that the position of the swivel arm can be varied in order to cause it to actuate the lowering operation more or less early. Furthermore, it is appreciated that the leverage can be adjusted by adjusting the length of the swivel arm. A greater leverage, and thereby a greater compressive force, can be obtained if the distance between the protruding portion of the swivel arm and the attachment for the rescue harness is increased. The shape of the swivel arm can be varied. If a different control method is desired, also the shape of the protruding portion can be varied. It is e.g. conceivable to give the protruding portion a contour adaptation to the braking means, wherein a longer contact length between the protruding portion of the swivel arm and the lifeline is obtained. The deflecting means can have a different shape than the one shown, in order to thus change the contact length of the lifeline around them. For example, also the lower deflecting means can be given an elliptical shape. The deflecting means can be given different polygonal shapes and one and the same deflecting means can be designed as a combination of shapes. Super ellipses of different types presenting convex sides with rounded corners, e.g. a shape called a Reuleaux triangle, would seem to be suitable. Furthermore, it is appreciated that the relative position of the deflecting means, and their position relative to the swivel arm, can be changed. The orientation of the deflecting means can be changed, e.g. an elliptical upper deflecting means can be oriented so that its “longitudinal axis” is made more parallel oriented to the sloping side of the protruding portion on the swivel arm, so that the engagement of the swivel arm takes place in the more flat portion on the deflecting means. Instead of side supporting walls, the deflecting means can be provided with side supporting rims which, however, do not allow as rational a production. Like the lowering device previously disclosed in the applicant's patent No. EP 1622687, a wraparound protective sleeve, in the form of deflecting means, can be positioned in the outlet opening with the purpose of reducing the risk that the lifelines align themselves laterally to each other at the upper deflecting means even further.

1-7. (canceled)

8. A lowering device comprising:
a base part;
a handle;
a lifeline; and
an attachment for a rescue harness or a safety belt, wherein the base part and the handle are fixedly connected to each other, wherein the base part comprises a first deflecting means and a second deflecting means, that said first deflecting means also constitutes a braking means located adjacent to an outlet opening for the lifeline, that a first, incoming portion of the lifeline is adapted to run around said first deflecting means while bearing against a contact surface (A) of said first deflecting means, that a second, outgoing portion of the lifeline is adapted to run around said second deflecting means and further out through the outlet opening while when under load it abuts in frictional engagement against the first incoming portion of the lifeline along at least part of the length where the first lifeline bears against said contact surface (A), that a fulcrum (M) is formed in an abutment region between the two portions of the lifeline and the contact surface (A), that the handle and the attachment are positioned on either side of the first deflecting means and adapted to rotate the base part in a common rotational plane about said fulcrum (M), that the attachment comprises a swivel arm which is rotatably connected to the base part on a pivot point for rotation of the swivel arm in said rotational plane (P) and an attachment means for said rescue harness or safety belt, wherein the swivel arm is designed to be brought into engagement with said second portion of the lifeline in the abutment region between the two portions of the lifeline and the contact surface (A) for producing a compressive force (F) against the lifeline, whereby the abutment contact between the two portions of the lifeline, and thereby the frictional force, can be increased.

9. The lowering device according to claim 8, wherein said engagement against the lifeline is produced by a portion of the swivel arm protruding in said rotational plane (P).

10. The lowering device according to claim 9, wherein said protruding portion is positioned in a position between the pivot point and an attachment means for said rescue harness or safety belt, wherein the swivel arm forms a one-armed lever where the compressive force is adjusted by rotation of the base part in the rotational plane (P), wherein a rotation angle (v) formed between a longitudinal axis of the swivel arm and a longitudinal axis of the handle is decreased or increased.

11. The lowering device according to claim 10, wherein the transmission ratio of the swivel arm amounts to a factor of at least 1:1, wherein the compressive force which it exerts on the lifeline becomes so large that the rotation angle (v) between a self locking position (SLP) and a panic position (PLP) amounts to a maximum of 100°.

12. The lowering device according to claim 10, wherein the transmission ratio of the swivel arm amounts to a factor of at least 1:2, wherein the compressive force which it exerts on the lifeline becomes so large that the rotation angle (v) between a self locking position (SLP) and a panic position (PLP) amounts to a maximum of 75°.

13. The lowering device according to claim 11, wherein the rotation angle (v) for controlling the lowering operation amounts to a maximum of 45°.

14. The lowering device according to claim 13, wherein the protruding portion of the swivel arm is brought into engagement with the lifeline when the rotation angle (v) has been decreased with no more than 45° from a maximum in the self locking position.

15. The lowering device according to claim 8, wherein said first deflecting mean has an elliptical shape, and wherein the contact surface (A) is positioned along the side having the largest circle radius.
